(19) United States
(12) Patent Application Publication
(10) Pub. No.: US 2003/0142217 A1
(43) Pub. Date: Jul. 31, 2003

(54) Digital camera

(76) Inventors: Shinichi Maehama, Osaka (JP); Yasuhiro Kingetsu, Osaka (JP); Makoto Arioka, Ikoma-Shi (JP)

Correspondence Address: MCDERMOTT WILL & EMERY, 600 13TH STREET, N.W., WASHINGTON, DC, 20005-3096, US

(21) Appl. No.: 10/354,184

(22) Filed: Jan. 30, 2003

(30) Foreign Application Priority Data
Jan. 30, 2002 (JP) P2002-021858

(51) Int. Cl. H04N 5/262

(52) U.S. Cl. 348/207.99; 348/231.5; 348/239

(57) ABSTRACT

The present invention provides a digital camera capable of reducing its power consumption. A digital camera includes a microprocessor (central processing unit), peripheral processing circuits for executing a data process on image data so as to share with the microprocessor, and a clock supplying circuit for supplying clocks to the microprocessor. In the digital camera, when the microprocessor requests the peripheral processing circuits to perform at least a part of the data process, thereby satisfying a condition such that a process to be shared and executed by the microprocessor does not exist, the clock supplying circuit stops supplying clocks to the microprocessor.

This application is based on application No. 2002-021858 filed in Japan, the contents of which are hereby incorporated by reference.

### BACKGROUND OF THE INVENTION

1. Field of the Invention

The present invention relates to a digital camera.

2. Description of the Background Art

In a digital camera, the number of pixels is increasing year after year. Meanwhile, in spite of increase in the amount of image data in association with the increase in the number of pixels, a demand of improvement in response in operation exists. However, only by a software process by a microprocessor, it is difficult to process such a large amount of data at high speed.

In such circumstances, in a recent digital camera, both of a microprocessor (central processing unit) for performing a software process and hardware (peripheral processing circuits) dedicated to partial image processing functions are used. The microprocessor and the peripheral processing circuits share and execute various data processes in cooperation with each other, thereby displaying predetermined functions. By such a cooperation, higher processing speed is achieved.

However, in such a conventional digital camera, at the time of performing an image process, both of the microprocessor and the peripheral processing circuits are in an operating state. Since the microprocessor operates in a driving state based on clocks for driving of high frequencies, its power consumption is originally relatively high. When the power consumption of the peripheral processing circuits which operate simultaneously is also added, a problem such that the power consumption in the digital camera is very high arises. Due to high power consumption, a detriment such as shorter battery life of a device generates.

### SUMMARY OF THE INVENTION

An object of the present invention is to provide a digital camera capable of reducing its power consumption.

To achieve the object, according to one aspect of the present invention, a digital camera includes: a central processing unit; a peripheral processing circuit for sharing a data process on image data with the central processing unit; and a clock supplying circuit for supplying clocks to the central processing unit. The clock supplying circuit stops supplying clocks to the central processing unit when the central processing unit requests the peripheral processing circuit to execute at least a part of a predetermined data process and the condition that there remain no process parts to be executed by the central processing unit is satisfied.

According to the above digital camera, at the time of executing the predetermined data process, when the central processing unit requests the peripheral processing circuit to perform at least a part of the predetermined data process, thereby satisfying a condition such that a process to be shared and executed does not exist in the central processing unit, the clock supplying circuit stops supplying clocks to the central processing unit. Thus, power consumption can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the outline of a hardware configuration of a digital camera according to a first embodiment;

FIG. 2 is a diagram showing processes performed by a microprocessor and processes performed by peripheral processing circuits with lapse of time;

FIG. 3 is a memory map showing a storing state of each of images G1 and G2;

FIG. 4 is a flowchart showing a main routine;

FIG. 5 is a flowchart showing detailed operation of a process P1;

FIG. 6 is a flowchart showing detailed operation of a process P2;

FIG. 7 is a flowchart showing detailed operation of a part (SP24) of the process P2;

FIG. 8 is a flowchart showing detailed operation of a part (SP25) of the process P2;

FIG. 9 is a flowchart showing detailed operation of a process P3;

FIG. 10 is a flowchart showing detailed operation of a part (SP34) of the process P3;

FIG. 11 is a flowchart showing detailed operation of a process P4;

FIG. 12 is a diagram for describing operation in live-view display;

FIG. 13 is a diagram for describing an operation according to a second embodiment;

FIG. 14 is a flowchart showing detailed operation of a process P21;

FIG. 15 is a flowchart showing detailed operation of a part (SP101) of the process P21;

FIG. 16 is a flowchart showing detailed operation of a timer interrupt routine R1;

FIG. 17 is a flowchart showing detailed operation of a part (PS123) of a process P22;

FIG. 18 is a flowchart showing detailed operation of a part (SP124) of the process P22;

FIG. 19 is a flowchart showing detailed operation of a timer interrupt routine R2;

FIG. 20 is a flowchart showing detailed operation of a part (SP133) of a process P23;

FIG. 21 is a flowchart showing detailed operation of a timer interrupt routine R3;

FIG. 22 is a diagram for describing an operation according to a third embodiment;

FIG. 23 is a conceptual diagram for describing a time lag Δt; and

FIG. 24 is a diagram for describing detailed operation according to a modification.

### DESCRIPTION OF THE PREFERRED EMBODIMENTS

Hereinafter, embodiments of the present invention will be described with reference to the drawings.

A. First Embodiment

A1. Outline of Configuration

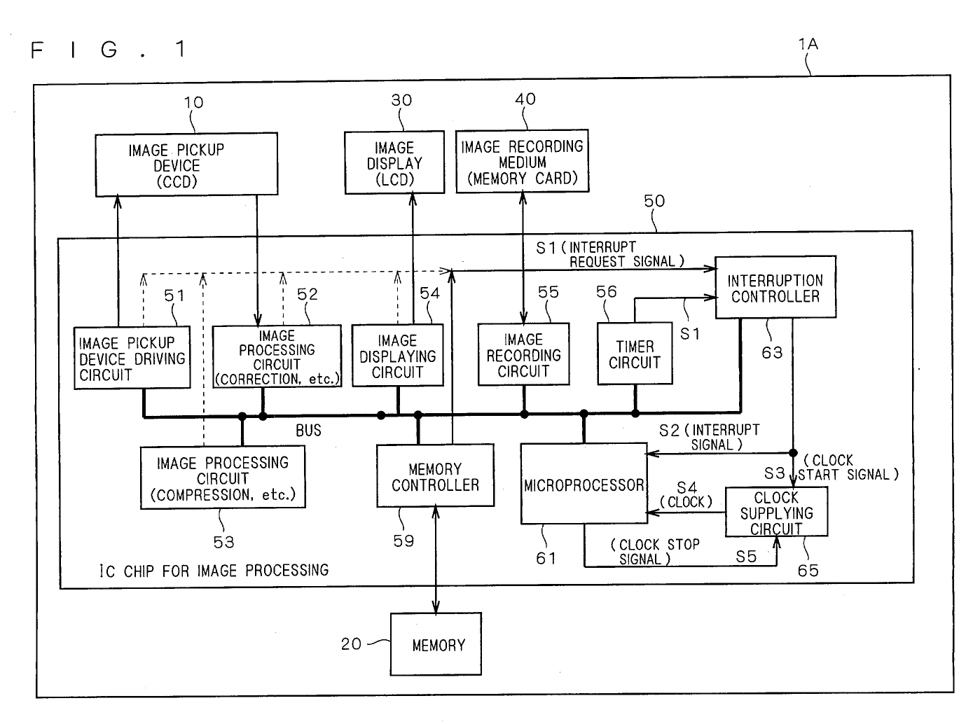

FIG. 1 is a block diagram showing the outline of a hardware configuration of a digital camera 1A according to a first embodiment, and more particularly, a block diagram showing a schematic configuration of hardware for performing various image processes. FIG. 1 shows not all the elements but only a part of elements of digital camera 1A, the digital camera 1A includes other elements (ex. lens and shutter start button) which are not shown in FIG. 1.

As shown in FIG. 1, the digital camera 1A includes an image pickup device 10, a memory 20, an image display 30, an image recording medium 40 such as a memory card, and an IC chip 50 for image processing.

The image pickup device 10 is a device for converting an optical image of a subject into an electric signal by photoelectric conversion and takes the form of, for example, a CCD.

The memory 20 is a memory for temporarily storing image data at the time of performing various image processes by the IC chip 50 for image processing and, takes the form of, for example, a semiconductor memory such as a RAM.

The image display 30 has a function of visualizing and displaying image data processed by the IC chip 50 for image processing and takes the form of, for example, an LCD.

The image recording medium 40 is a recording medium for recording image data. The image recording medium is a medium suitable for relatively long recording, and is constructed by using, preferably, a nonvolatile semiconductor memory. For example, various memory cards and the like can be employed as the image recording medium 40. Image data recorded on the image recording medium 40 does not disappear even when the power of the body of the digital camera 1A is turned off, but can be read again into the digital camera 1A and further can be read by various appliances other than the digital camera 1A.

The IC chip 50 for image processing is an IC chip having electronic circuits for executing various image processes on image data.

The IC chip 50 for image processing has an image pickup device driving circuit 51, image processing circuits 52 and 53, an image displaying circuit 54, an image recording circuit 55, a timer circuit 56, a memory controller 59, a microprocessor (central processing unit) 61, an interruption controller 63 and a clock supplying circuit 65.

The image pickup device driving circuit 51 is a circuit for generating a drive signal for operating the image pickup device 10.

The image processing circuit 52 is a circuit for performing an image processing process for processing an image signal (image data) from the image pickup device 10 and is, specifically, a circuit for performing a γ correcting process, a color interpolation process, a filtering process and an image size converting process. The image processing circuit 53 is, like the image processing circuit 52, a circuit for performing an image process on image data, specifically, for compressing and/or decompressing image data. In the specification, to discriminate from the image compressing (and/or decompressing) process performed by the image processing circuit 53, the processes of color interpolation, filtering and image size conversion performed by the image processing circuit 52 will be generically referred to as an “image adjusting process”.

The image displaying circuit 54 is a circuit for controlling an operation for transferring image data stored in the memory 20 or the like to the image display 30 via the memory controller 59 and displaying the transferred image on the image display 30.

The image recording circuit 55 is a circuit for controlling an operation of transferring image data stored in the memory 20 or the like to the image recording medium 40 and writing the image data into the image recording medium 40. The image recording circuit 55 is also a circuit for controlling an operation of transferring image data in the image recording medium 40 to the memory 20 via the memory controller 59 and reading the image data from the image recording medium 40. That is, the image recording circuit 55 is a circuit for controlling both the operation of writing image data to the image recording medium 40 and the operation of reading the image data from the image recording medium 40 and can be therefore referred to as an access controller for the image recording medium 40.

The timer circuit 56 is a circuit for transmitting an interrupt request signal S1 to the interruption controller 63 when preset time elapses.

The memory controller 59 controls transfer (or reception) of data (including image data) between the memory 20 and each of the circuits 51, 52, 53, 54, 55 and 59. Concretely, the memory controller 59 controls transfer of data between the memory 20 and the microprocessor 61, transfer of data between the memory 20 and the image pickup device driving circuit 51, transfer of data between the memory 20 and the image processing circuits 52 and 53, transfer of data between the memory 20 and the image displaying circuit 54, and transfer of data between the memory 20 and the image recording circuit 55. In the case of performing transfer (seemingly) simultaneously between the memory 20 and the plurality of circuits, the memory controller 59 plays the role of arbitrating (coordinating) a priority on transfer between any of the circuits and the memory 20 in accordance with a predetermined priority order.

The microprocessor 61 is a central processing unit (CPU) playing a centralized role in various processes. The circuits 51, 52, 53, 54, 55 and 59 correspond to the “peripheral processing circuits” sharing execution of the various processes on image data with the microprocessor 61.

The interruption controller 63 is a controller for controlling an interrupting operation. Concretely, the interruption controller 63 receives the interrupt request signal S1 from the peripheral processing circuits such as the memory controller 59 and the timer circuit 56 and, in response to the signal S1, transmits an interrupt signal S2 to the microprocessor 61. It enables the microprocessor 61 in an operation stop mode (a kind of a sleep state) to be reset to a normal mode (normal state).

The clock supplying circuit 65 is a circuit for supplying a clock signal (also simply referred to as “clock”) S4 as a reference of operation in the microprocessor 61 to the microprocessor 61. In the case where a predetermined condition is satisfied, the clock supplying circuit 65 stops supplying clocks to the microprocessor 61.

Sharing between the microprocessor 61 and the peripheral processing circuits will now be described.

At the time of execution of various data processes on image data, the microprocessor 61 requests the peripheral processing circuits to perform a part of the processes. When a condition such that a process to be shared and executed by the microprocessor 61 does not exist is satisfied, the microprocessor 61 transmits a clock stop signal S5 to the clock supplying circuit 65.

On receipt of the clock stop signal S5, the clock supplying circuit 65 stops supply of the clock S4 to the microprocessor 61. Consequently, the microprocessor 61 enters the operation stop mode and stops its operation.

In the operation stop mode, the supply of clocks to the microprocessor 61 is stopped, so that power consumption can be reduced. As the power consumption decreases, the battery life of the digital camera 1A can be prolonged. Heat generation of an appliance or the like can be suppressed in association with reduction in power consumption, so that deterioration in an image and the like caused by rise in temperature can be also suppressed.

On the other hand, when the microprocessor 61 shifts to the operation stop mode, the memory controller 59 or the like which is requested to perform a process executes the process such as data transfer.

After that, on completion of the requested process, the memory controller 59 transmits the interrupt request signal S1 to the interruption controller 63.

When the interrupt request signal S1 from the memory controller 59 is received, the interrupt controller 63 transmits the interrupt signal S2 to the microprocessor 61 and requests the microprocessor 61 to interrupt. Simultaneously, the interruption controller 63 transmits a clock start signal S3 indicative of start of supply of clocks for the microprocessor 61 to the clock supplying circuit 65.

When the clock start signal S3 is received, the clock supplying circuit 65 restarts supplying the clock S4 to the microprocessor 61.

When the interrupt signal S2 from the interruption controller 63 and the clock S4 from the clock supplying circuit 65 are received, the microprocessor 61 is reset from the operation stop mode to the normal mode.

A2. Operation (1)

Outline

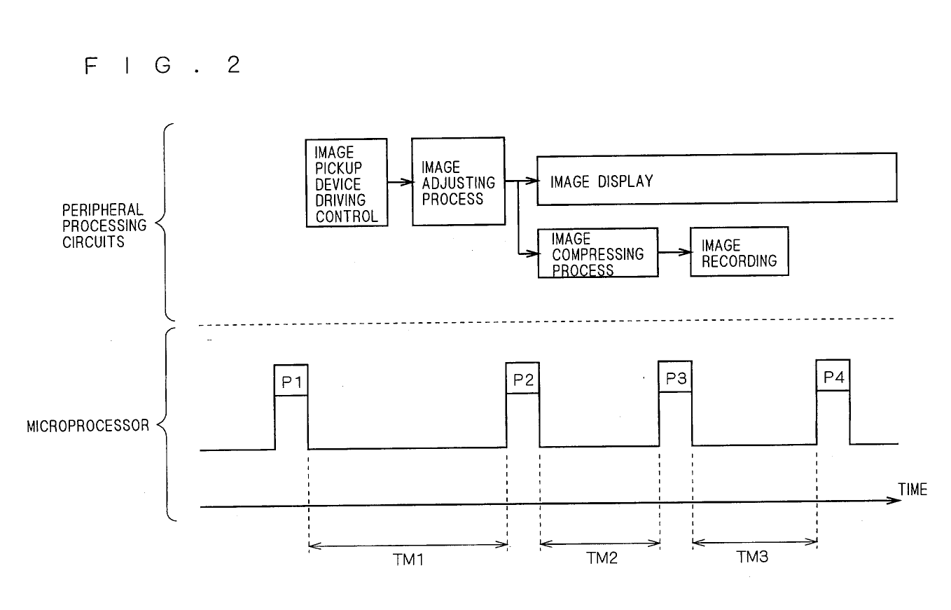

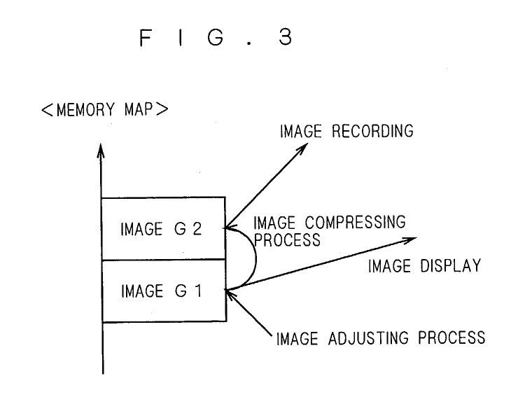

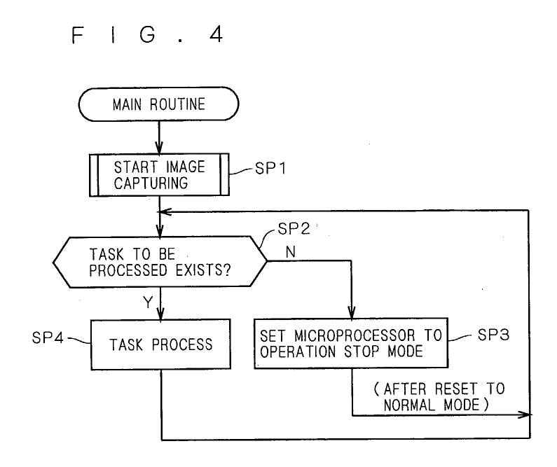

Referring now to FIGS. 2 to 11, the operation in the digital camera 1A will be described. FIG. 2 is a diagram showing processes performed by the microprocessor 61 and processes performed by the peripheral processing circuits with lapse of time. FIG. 3 is a memory map showing a storing state in a memory of each of images G1 and G2 generated by the processes. Further, FIGS. 4 to 11 are flowcharts showing the operations.

A case where the shutter start button of the digital camera 1A is depressed and an image capturing operation by the digital camera 1A is performed will be described here. More specifically, a case will be described in which the digital camera 1A performs an image processing process such as a correcting process by using the image processing circuit 52 on image data obtained by using the image pickup device 10, displays the corrected image on the image display 30 and performs a compressing process (image processing process) on the corrected image data and a process of recording the compressed image data to the image recording medium 40.

As shown in FIG. 2, in a period TM1 in which the image processing circuit 52 performs the image adjusting process while the image pickup device driving circuit 51 drives the image pickup device, the supply of clocks to the microprocessor 61 is stopped, and the microprocessor 61 is in the operation stop mode. Consequently, power consumption can be reduced.

Similarly, in a period TM2 in which the image processing circuit 53 performs the image compressing process and the image displaying circuit 54 performs the image displaying process, the supply of clocks to the microprocessor 61 is stopped, and the microprocessor 61 is in the operation stop mode. Consequently, the power consumption can be reduced.

In a period TM3 in which the image recording circuit 55 performs the image recording process, the supply of clocks to the microprocessor 61 is stopped, and the microprocessor 61 is in the operation stop mode. Consequently, the power consumption can be reduced.

Hereinafter, the operations will be described in more detail.

Image Capturing Process and Image Adjusting Process

First, an image capturing process is performed in step SP1 as shown in the flowchart of the main routine of FIG. 4. In the image capturing process, as shown in FIG. 2, accompanying the driving control on the image pickup device 10 by the image pickup device driving circuit 51 (FIG. 1), the microprocessor 61 performs a process P1 (which will be described later).

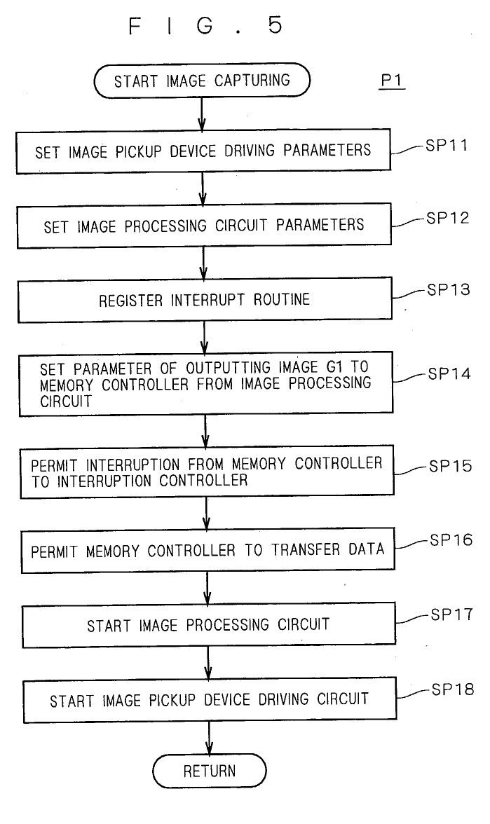

FIG. 5 is a flowchart showing the detailed operation of the process P1 in the microprocessor 61.

First, in step SP11, the microprocessor 61 changes the parameters of the image pickup device driving circuit 51 to set the driving mode of the image pickup device 10. For example, the driving mode is set to drive the image pickup device 10 according to either an interlace method or a progressive method.

In the following step SP12, the microprocessor 61 sets the parameters regarding processes to be executed in the image processing circuit 52. Concretely, the size of an image, a color converting method, a coefficient of a filter, an interpolating method and the like are set.

In step SP13, the microprocessor 61 registers a process (or task) P2 to be executed when the image adjusting process by the image processing circuit 52 is finished. Concretely, the microprocessor 61 registers an interrupt routine for performing the process P2. The interrupt routine is a routine activated in response to the interrupt signal S2 which is generated on completion of the image adjusting process.

In step SP14, the microprocessor 61 sets parameters such as a storage address (output destination address) in which still image data G1 is to be stored for the memory controller 59. The still image data G1 is still image data subjected to the image adjusting process by the image processing circuit 52. As will be described later, under control of the memory controller 59, the still image data G1 is outputted to a predetermined storage address from the image processing circuit 52 in accordance with address information which is set.

In step SP15, the microprocessor 61 sets the interruption controller 63 so as to permit reception of the interrupt request signal S1 from the memory controller 59.

In step SP16, the microprocessor 61 permits the memory controller 59 to transfer data. The microprocessor 61 allows the image processing circuit 52 to start operating (step S17) and also allows the image pickup device driving circuit 51 to start operating (step SP18).

Accordingly, the image pickup device 10 is driven under control of the image pickup device driving circuit 51 to output captured image data of the subject to the image processing circuit 52. The image processing circuit 52 performs a predetermined process on the captured image data sent from the image pickup device 10 and outputs the still image data G1 subjected to the adjusting process to a predetermined address in the memory 20. In such a manner, the still image data G1 is generated and stored into the predetermined address in the memory 20 (see FIG. 3).

After step SP18, in step SP2 (FIG. 4), the microprocessor 61 determines whether there is a task to be executed or not.

In the case where there is no task to be executed, the microprocessor 61 shifts itself to the operation stop mode. In this case, when step SP18 is finished, the microprocessor 61 has no process to be shared and executed. Consequently, the microprocessor 61 shifts itself into the operation stop mode. To be concrete, the microprocessor 61 outputs the clock stop signal S5 to the clock supplying circuit 65, thereby stopping the supply of clocks from the clock supplying circuit 65 to the microprocessor 61.

As described above, the microprocessor 61 requests the image processing circuit 52 to perform the image adjusting process in the process P1 and, after that, shifts itself into the operation stop mode. Specifically, in the period TM1, the image pickup device driving circuit 51 performs the image pickup device driving control process and the image processing circuit 52 performs the image adjusting process, meanwhile the microprocessor 61 is in the operation stop mode. As described above, in the period TM1, the clocks are not supplied to the microprocessor 61, and the microprocessor 61 is in the operation stop mode, so that the power consumption can be reduced.

When the image adjusting process by the image processing circuit 52 is finished, the microprocessor 61 is restarted by an interruption (which will be described later) by the interruption controller 63. The microprocessor 61 determines again whether or not there is a task to be processed in step SP2. If there is a task to be executed, the microprocessor 61 processes the task (step SP4). In this situation, concretely, a process (task) P2 for starting the next image displaying process and the image compressing process exists. In the following, the details of such operation will be described.

In the period where the microprocessor 61 is in the operation stop mode (concretely, in the period TM1), the image pickup device driving circuit 51 drives the image pickup device and the image processing circuit 52 performs the image adjusting process requested by the microprocessor 61. Concretely, the image interpolation circuit 52 performs the above-described γ correcting process, color interpolation process, filtering process and image size converting process on the still image data transferred from the image pickup device 10. The still image data G1 subjected to the image process is transferred to the memory 20 by the memory controller 59 and stored into a predetermined address in the memory 20.

When the memory controller 59 detects completion of the operation of transferring the still image data G1 subjected to the image adjusting process to the memory 20, the memory controller 59 determines that the requested image adjusting process or the like has been completed. In order to reset the microprocessor 61 in the operation stop mode into the normal mode, the memory controller 59 outputs the interrupt request signal S1 to the interruption controller 63. In response to the interrupt request signal S1, the interruption controller 63 outputs the interrupt signal S2 and the clock start signal S3. The clock supplying circuit 65 which has received the clock start signal S3 restarts supplying the clock S4 to the microprocessor 61.

In response to the interrupt signal S2, the microprocessor 61 restarts the operation on the basis of the clock S4 and is reset to the normal mode from the operation stop mode. The microprocessor 61 determines that a task to be executed exists (step SP2) and executes the process (task) P2 (step SP4). Concretely, the microprocessor 61 executes the interrupt routine registered in step SP13.

Image Displaying Process and Image Compressing Process

The microprocessor 61 which is reset in the normal mode executes the process P2 (FIG. 2), thereby allowing the image displaying circuit 54 to start the image displaying process and allowing the image processing circuit 53 to start the image compressing process.

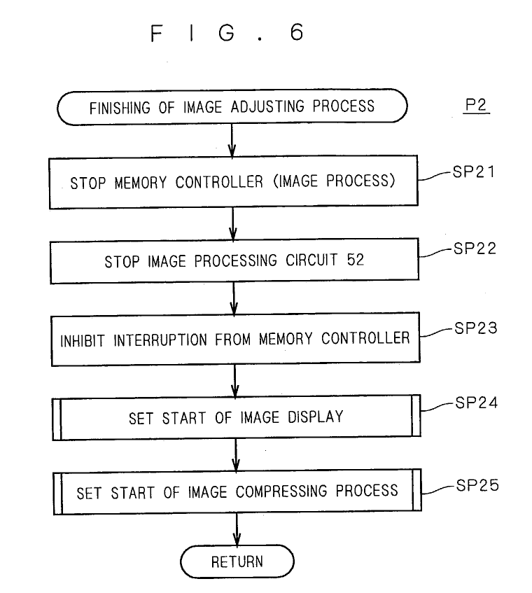

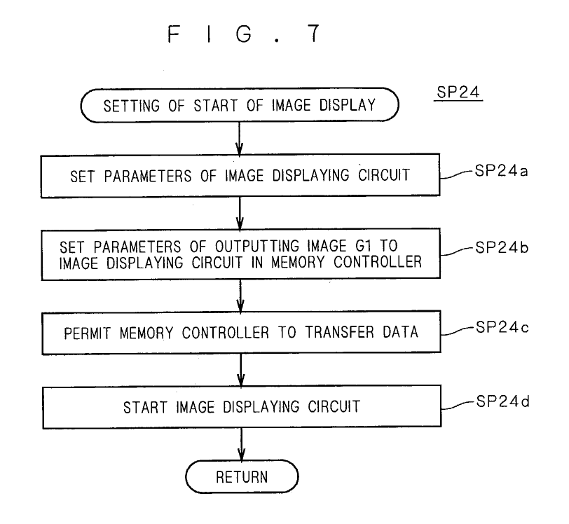

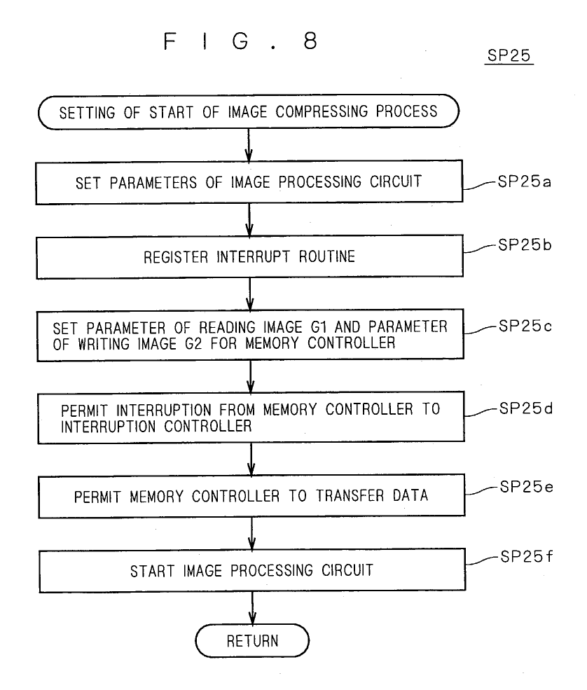

FIG. 6 is a flowchart showing the flow of the process P2. FIGS. 7 and 8 are flowcharts showing a part of the process P2.

First, as shown in FIG. 6, the microprocessor 61 stops the memory controller 59 (step SP21) and stops the image processing circuits 52 and 53 (step SP22). The microprocessor 61 sets the interruption controller 63 so as not to accept the interrupt request signal S1 from the memory controller 59 (step SP23), thereby inhibiting interruption from the memory controller 59 which has been permitted in step SP16.

In step SP24, a process for allowing the image displaying circuit 54 to start the image displaying process is performed. FIG. 7 is a flowchart showing the detailed operation of step SP24.

As shown in FIG. 7, in step SP24a, the microprocessor 61 sets parameters regarding a display state in the image display 30 for the image displaying circuit 54. Concretely, setting for changing the display state of the image display 30 from “live view” to “after view” is made. The “live view” indicates a state where images of the subject being captured prior to instruction of actual image recording are displayed as motion images on the image display 30. The “after view” indicates a state where a captured image of the subject is displayed as a still image on the image display 30 in response to instruction of actual image recording.

In step SP24b, the microprocessor 61 sets parameters such as the address in which the still image data G1 to be displayed is stored for the memory controller 59. As will be described later, under control of the memory controller 59, the still image data G1 is read in accordance with the set address information and is outputted to the image display 30 via the image displaying circuit 54.

In step SP24c, the microprocessor 61 permits the memory controller 59 to transfer data.

Further, in step SP24d, the microprocessor 61 makes the image displaying circuit 54 start operating.

Further, in step SP25, a process for allowing the image processing circuit 53 to start the image compressing process is performed. FIG. 8 is a flowchart showing the detailed operation of step SP25.

In step SP25a, the microprocessor 61 sets parameters regarding a process to be executed in the image processing circuit 53. Concretely, parameters such as an image compressing ratio and the like are set.

In step SP25b, the microprocessor 61 registers a process (or task) P3 to be executed when the image compressing process by the image processing circuit 53 is finished. To be concrete, the microprocessor 61 registers an interrupt routine for performing the process P3. The interrupt routine is a routine which starts in response to the interrupt signal S2 which is generated on completion of the image compressing process.

In step SP25c, the microprocessor 61 sets the parameters such as the address in which the still image data G1 is stored for the memory controller 59. The microprocessor 61 also sets the parameters such as the storage destination address for storing the still image data G2 (or output destination address) for the memory controller 59. The still image data G2 is compressed still image data subjected to the image compressing process by the image processing circuit 53. As will be described later, the still image data G1 is read out from a predetermined address in the memory 20, transferred to the image processing circuit 53, subjected to a proper compressing process by the image processing circuit 53, after that, transferred again into the memory 20, and stored as still image data G2 into the predetermined storage destination address.

In step SP25d, the microprocessor 61 sets the interruption controller 63 so as to permit reception of the interrupt request signal S1 from the memory controller 59. In step SP25e, the microprocessor 61 permits the memory controller 59 to transfer data. Further, in step SP25f, the microprocessor 61 allows the image processing circuit 53 to start operating.

After performing such process, the process P2 is finished. When step SP25f is finished, the microprocessor 61 does not have a process to be shared and executed, so that the microprocessor 61 shifts itself into the operation stop mode. Concretely, the microprocessor 61 outputs the clock stop signal S5 to the clock supplying circuit 65. It stops the supply of clocks from the clock supplying circuit 65 to the microprocessor 61, and the microprocessor 61 shifts to the operation stop mode.

After that, as will be described later, the microprocessor 61 remains in the operation stop mode until the interrupt signal S2 from the interruption controller 63 based on the interrupt request signal S1 from another circuit is received.

As described above, the microprocessor 61 requests the image processing circuit 53 to perform the image compressing process and requests the image displaying circuit 54 to perform the image displaying process in the process P2 and, after that, shifts itself into the operation stop mode. That is, in the period TM2, the image processing circuit 53 performs the image adjusting process and the image displaying circuit 54 performs the image displaying process and, meanwhile the microprocessor 61 is in the operation stop mode. Since the microprocessor 61 does not receive supply of clocks and is in the operation stop mode in the period TM2, power consumption can be reduced.

During the microprocessor 61 is in the operation stop mode (concretely, in the period TM2), the image displaying circuit 54 performs the requested image displaying process. Concretely, the image displaying circuit 54 performs the process of outputting data to the image display 30 on the basis of the still image data G1 stored in a predetermined address in the memory 20 in cooperation with the memory controller 59.

In parallel with the image displaying process, the image processing circuit 53 performs the requested image compressing process. Concretely, the image processing circuit 53 performs an operation of compressing the still image data G1 into a predetermined format (for example; the JPEG format) in cooperation with the memory controller 59.

More specifically, the memory controller 59 reads out the still image data G1 stored in a predetermined address from the memory 20 and transfers it to the image processing circuit 53. The image processing circuit 53 performs the compressing process on the transferred still image data G1. The memory controller 59 transfers the still image data subjected to the compressing process to the memory 20 and stores it as still image data G2. It is assumed here that the still image data G1 and the still image data G2 are stored in different addresses in the memory 20. The memory controller 59 obtains the address information of the still image data G1 and G2 by the setting operation by the microprocessor 61 in steps SP25c and SP25d.

When the memory controller 59 detects completion of the operation of transferring the still image data G2 subjected to the image compressing process to the memory 20, the memory controller 59 determines that the requested image compressing process has been completed. To reset the microprocessor 61 in the operation stop mode into the normal mode, the memory controller 59 outputs the interrupt request signal S1 to the interruption controller 63. The interruption controller 63 outputs the interrupt signal S2 and the clock start signal S3 in response to the interrupt request signal S1. The clock supplying circuit 65 which has received the clock start signal S3 restarts the supply of the clocks S4 to the microprocessor 61.

In response to the interrupt signal S2, the microprocessor 61 restarts the operation based on the clock S4 and is reset from the operation stop mode to the normal mode. At this time, the microprocessor 61 determines that a task to be executed exists (step SP2) and executes the process (task) P3 (step SP4). Concretely, the microprocessor 61 executes the interrupt routine registered in step SP25b.

Image Recording Process

The microprocessor 61 reset to the normal mode executes the process P3 (FIG. 2), thereby making the image recording circuit 55 start performing an image recording process.

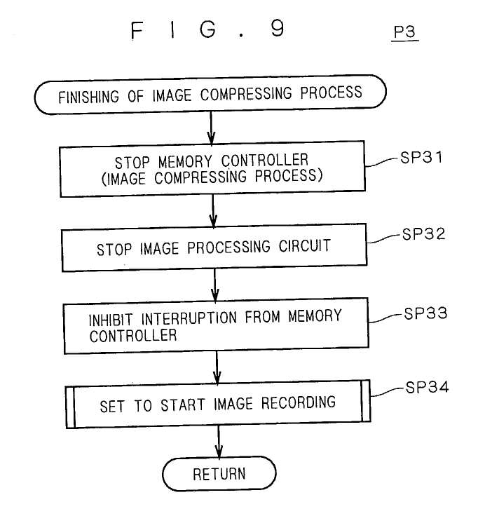

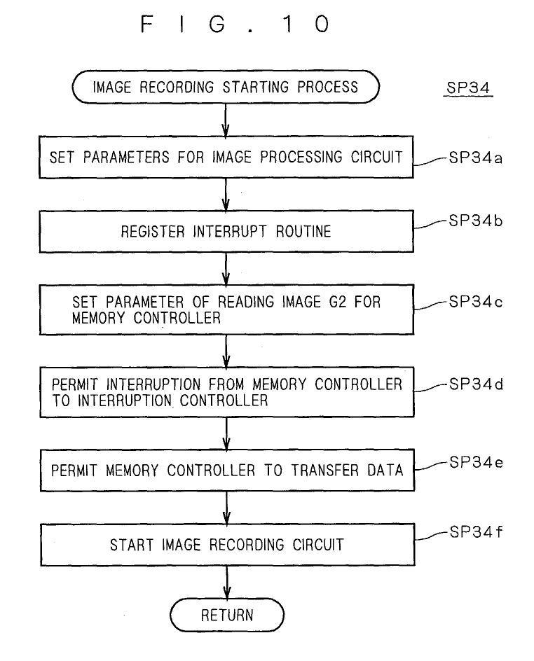

FIG. 9 is a flowchart showing the flow of the process P3. FIG. 10 is a flowchart showing the flow of a part (step SP34) of the process P3.

First, as shown in FIG. 9, the microprocessor 61 stops the memory controller 59 (step SP31) and stops the image processing circuit 53 (step SP32). The microprocessor 61 sets the interruption controller 63 so as not to receive the interrupt request signal S1 from the memory controller 59 (step SP33), thereby inhibiting interruption from the memory controller 59 which was permitted in step SP25d.

In step SP34, a process of making the image recording circuit 55 start the image recording process is performed.

As shown in FIG. 10, in step SP34a, the microprocessor 61 sets parameters regarding image recording to the image recording medium 40 for the image recording circuit 55. Concretely, parameters such as the kind of a memory medium and an access timing are set.

In step SP34b, the microprocessor 61 registers a process (or task) P4 to be executed when the image recording process by the image recording circuit 55 is finished. Concretely, the microprocessor 61 registers the interrupt routine for performing the process P4. The interrupt routine is a routine to be started in response to the interrupt signal S2 generated on completion of the image recording process.

In step SP34c, the microprocessor 61 sets parameters such as an address in which the still image data G2 to be recorded is stored for the memory controller 59. As will be described later, under control of the memory controller 59, the still image data G2 is read out in accordance with the set address information and is outputted to the image recording medium 40 via the image recording circuit 55.

In step SP34d, the microprocessor 61 sets the interrupt controller 63 so as to permit reception of the interrupt request signal S1 from the memory controller 59.

In step SP34e, the microprocessor 61 permits the memory controller 59 to transfer data.

In step SP34f, the microprocessor 61 allows the image recording circuit 55 to start operating.

After such processes, the process P3 is finished. When step SP34f is finished, the microprocessor 61 does not have a process to be shared and executed and, therefore, shifts itself into the operation stop mode. Concretely, the microprocessor 61 outputs the clock stop signal S5 to the clock supplying circuit 65. It stops the supply of clocks from the clock supplying circuit 65 to the microprocessor 61, and the microprocessor 61 shifts to the operation stop mode.

In such a manner, the microprocessor 61 requests the image recording circuit 55 to perform the image recording process in the process P3 and, after that, shifts itself into the operation stop mode. That is, in the period TM3, the image recording circuit 55 performs the image recording process and, meanwhile, the microprocessor 61 is in the operation stop mode. Thus, power consumption can be reduced.

During the microprocessor 61 is in the operation stop mode (concretely, in the period TM3), the image recording circuit 55 performs the requested image recording process. Concretely, the image recording circuit 55 performs a process of transferring the still image data G2 stored in a predetermined address in the memory 20 and recording it into the image recording medium 40 in cooperation with the memory controller 59.

When the memory controller 59 detects completion of the operation of transferring the still image data G2 to the image recording medium 40, the memory controller 59 determines that the requested image recording process has been completed. In order to reset the microprocessor 61 in the operation stop mode into the normal mode, the memory controller 59 outputs the interrupt request signal S1 to the interruption controller 63. In response to the interrupt request signal S1, the interruption controller 63 outputs the interrupt signal S2 and the clock start signal S3. The clock supplying circuit 65 which has received the clock start signal S3 restarts the supply of the clocks S4 to the microprocessor 61.

In response to the interrupt signal S2, the microprocessor 61 restarts operation based on the clocks S4 and is reset from the operation stop mode to the normal mode. The microprocessor 61 determines that a task to be executed exists and executes the process (task) P4 (step SP4). Concretely, the microprocessor 61 executes the interruption routine registered in step SP34b.

Finishing Process

The microprocessor 61 reset into the normal mode executes the process P4 (FIG. 2), thereby performing the process of finishing the image recording.

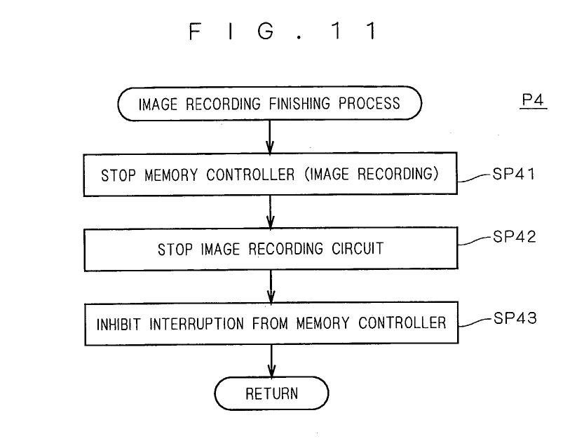

FIG. 11 is a flowchart showing the flow of the process P4.

As shown in FIG. 11, the microprocessor 61 stops the memory controller 59 (step SP41) and stops the image recording circuit 55 (step SP42). The microprocessor 61 sets the interruption controller 63 so that the interruption controller 63 does not accept the interrupt request signal S1 from the memory controller 59 (step SP43). It inhibits interruption of the memory controller 59 which was permitted in step SP25d.

By the above-described operation, the captured image is recorded on the image recording medium 40.

After that, the microprocessor 61 enters a state where it does not have a process to be shared and executed and, therefore, shifts itself into the operation stop mode. The operation stop mode is maintained until the next task occurs. In the operation stop mode, supply of clocks from the clock supplying circuit 65 to the microprocessor 61 is stopped, so that power consumption can be reduced.

After lapse of predetermined time, the interrupt controller 63 which has received the interrupt request signal S1 from the timer circuit 56 transmits the interrupt signal S2 to the microprocessor 61 to shift the microprocessor 61 into the normal mode. In such a manner, by performing predetermined processes by the microprocessor 61, live view display in the digital camera is realized.

A3. Operation (2)

The operation of the digital camera 1A in the case of performing live view display will now be described. The live view display is realized by continuously displaying images (still images) captured at small time intervals on the image display 30.

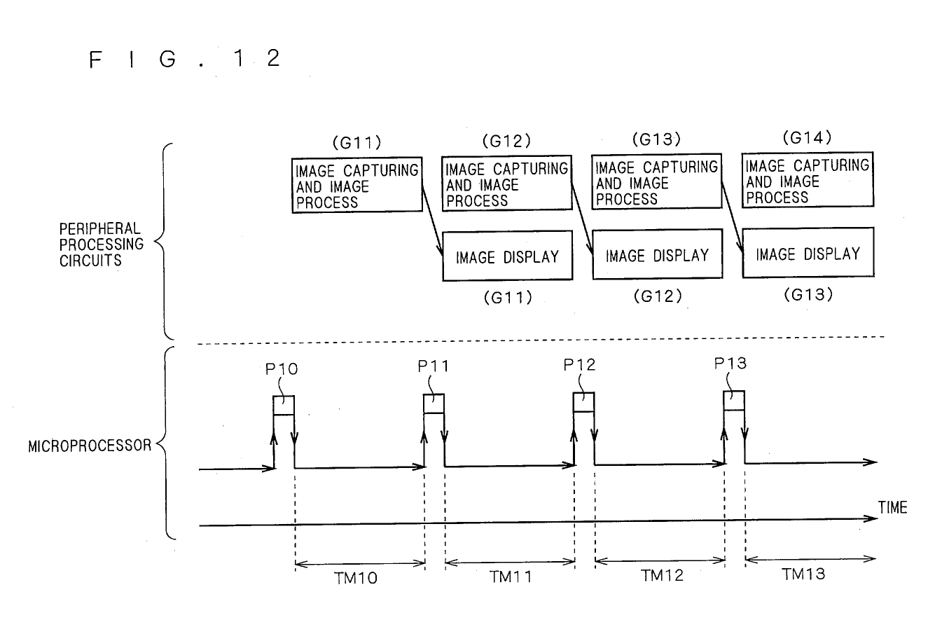

FIG. 12 is a diagram showing processes performed by the microprocessor 61 and processes performed by the peripheral processing circuits with lapse of time.

First, the microprocessor 61 executes a process P10 including the following detailed processes. Specifically, the microprocessor 61 sets various parameters for the image processing circuit 52, sets the address to which a captured image G11 is stored for the memory controller 59, and requests the image pickup device driving circuit 51 and image processing circuit 52 to perform the image capturing process and the image adjusting process (which has been described above), respectively. The microprocessor 61 itself shifts to the operation stop mode in which the supply of clocks from the clock supplying circuit 65 is stopped. The interruption controller 63 enters a state where it accept an interrupting process from the memory controller 59. Consequently, in future, the microprocessor 61 can be reset to the normal mode in response to an interrupt signal from the memory controller 59, or the like.

In a period TM10 in which the microprocessor 61 is in the operation stop mode, the image pickup device driving circuit 51 performs the image capturing process and the image processing circuit 52 performs the image adjusting process. A captured image G11 processed by the image processing circuit 52 is stored in an address designated in the memory 20.

After transferring all of the captured images G11 to the memory 20, the memory controller 59 transmits the interrupt request signal S1 to the interruption controller 63. In response to the interrupt request signal S1, the interruption controller 63 transmits the interrupt signal S2 to the microprocessor 61. The microprocessor 61 is reset to the normal mode in response to the interrupt signal S2. The clock S4 as a reference of the operation is supplied to the microprocessor 61 by the clock supplying circuit 65 which has restarted the operation in response to the interrupt signal S2.

Subsequently, the microprocessor 61 executes a process P11.

Concretely, the microprocessor 61 sets various parameters for the image processing circuit 52 as necessary, sets the address to which the next captured image G12 is to be stored in the memory controller 59, and sets the address in which the image G11 captured in the period TM10 is stored into the memory controller 59. Further, the microprocessor 61 requests the image pickup device driving circuit 51, image processing circuit 52 and image displaying circuit 54 to perform the image capturing process, image adjusting process and image displaying process, respectively, and shifts itself into the operation stop mode.

After that, in a period TM11 in which the microprocessor 61 is in the operation stop mode, the image displaying circuit 54 reads the captured image G11 stored in the memory 20 under control of the memory controller 59, performs a predetermined process for display output on the captured image G11, and outputs the processed image to the image display 30. Meanwhile, the image pickup device driving circuit 51 performs the image capturing process and the image processing circuit 52 performs the image adjusting process. The next captured image G12 processed by the image processing circuit 52 is stored into an address designated in the memory 20.

Subsequently, the microprocessor 61 executes the process P12.

Concretely, the microprocessor 61 sets various parameters in the image processing circuit 52 as necessary, sets the address to which the next captured image G13 is to be stored in the memory controller 59, and sets the address in which the captured image G12 obtained in the period TM11 is stored for the memory controller 59. Further, the microprocessor 61 requests the image pickup device driving circuit 51, image processing circuit 52 and image displaying circuit 54 to perform the image capturing process, image adjusting process and image displaying process, respectively, and shifts itself into the operation stop mode.

After that, in a period TM12 in which the microprocessor 61 is in the operation stop mode, under control of the memory controller 59, the image displaying circuit 54 reads the captured image G12 stored in the memory 20, performs a predetermined process for display output on the image G12, and outputs the processed image to the image display 30. Meanwhile, the image pickup device driving circuit 51 performs the image capturing process, and the image processing circuit 52 performs the image adjusting process. The next captured image G13 processed by the image processing circuit 52 is stored into the address designated in the memory 20.

After that, similar operations are repeated. By sequentially displaying captured images on the image display 30, the live view display is realized. In each of the periods TM10, TM11, TM12, TM13, . . . , supply of clocks to the microprocessor 61 is stopped, so that power consumption can be reduced.

In the first embodiment, the interruption controller 63 accepts interruption from the memory controller 59. However, the present invention is not limited to the case. For example, instead of receiving the interrupt request signal S1 from the memory controller 59, the interruption controller 63 may receive the interruption request signal S1 directly from any of the image pickup device driving circuit 51, image processing circuits 52 and 53, image displaying circuit 54 and image recording circuit 55 not via the memory controller 59, as shown by broken lines in FIG. 1.

Concretely, the interruption controller 63 generates the interrupt signal S2 in response to the interrupt request signal S1 from any of the circuits 51, 52, 53, 54 and 55. In response to the interrupt signal S2, the microprocessor 61 is reset to the normal mode and executes the interrupting process. In such a manner, the microprocessor 61 is reset from the operation stop mode to the normal mode and executes the interrupting process in response to the interrupt request from any of the circuits 51, 52, 53, 54 and 55 via the interruption controller 63. When the microprocessor 61 determines that a processed to be shared and executed by itself does not exist in the interrupting process (or after the interrupting process), the microprocessor 61 transmits the clock stop signal S5 to the clock supplying circuit 65 and shifts itself to the operation stop mode. Also by such operations, power consumption can be reduced.

B. Second Embodiment

B1. Outline

A second embodiment will now be described. In the following, different points from the first embodiment will be mainly described.

In the second embodiment, a case of executing the image adjusting process, image displaying process, image compressing process and image recording process at the time of image capturing in the above-described data processes will be described.

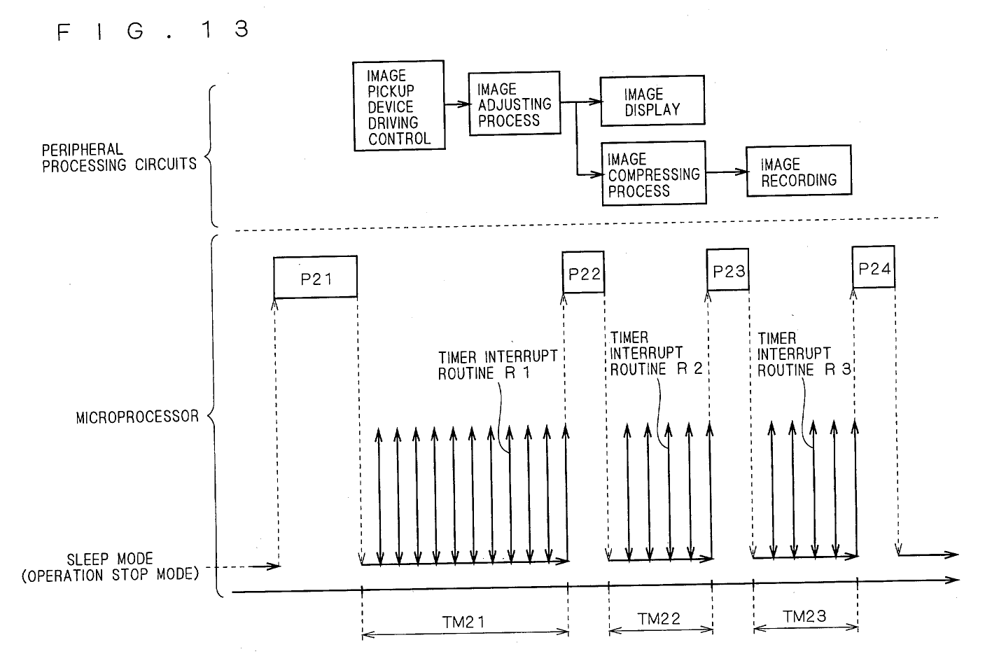

FIG. 13 is a diagram showing processes P21, P22, P23 and P24 performed by the microprocessor 61 and processes performed by the peripheral processing circuits with lapse of time.

A digital camera 1B of the second embodiment has a configuration similar to that of the digital camera 1A of the first embodiment but is different from the digital camera 1A with respect to the following points. In the first embodiment, the case of notifying the microprocessor 61 of completion of the requested process on the basis of the interrupt request signal S1 from the memory controller 59 or the like, resetting the microprocessor 61 from the operation stop mode to the normal mode, and performing a preparing process for requesting the following process has been described.

The second embodiment is different from the first embodiment with respect to the point that the microprocessor 61 is reset from the operation stop mode to the normal mode by performing the interrupting process at predetermined intervals by using the timer circuit 56 and, when the microprocessor 61 reset in the normal mode detects completion of the requested process, the preparing process for requesting the following process is performed. In short, the second embodiment is different from the first embodiment with respect to the point that the completion of the requested process is detected by using timer interruption.

Concretely, the microprocessor 61 requests at least one of the peripheral processing circuits 51, 52, 53, 54 and 55 to perform a part of the process and shifts itself to the operation stop mode. After that, when the microprocessor 61 is reset to the normal mode during a process of timer interruption which generates at predetermined intervals, the microprocessor 61 recognizes the state of the peripheral processing circuits and determines whether a condition such that a process to be shared and executed by the microprocessor 61 does not exist is satisfied or not.

According to the result of determination, the microprocessor 61 determines whether the following process (any of P22, P23 and P24) is performed or the microprocessor 61 itself is shifted again to the operation stop mode. Concretely, when the condition is satisfied, the microprocessor 61 stops again the supply of clocks from the clock supplying circuit 65 to the microprocessor 61. On the other hand, when the condition is not satisfied (for example, when a process to be executed by the microprocessor 61 exists such as a case where a process for shifting to the next process on completion of a requested process exists), the microprocessor 61 executes the process.

For example, as shown in FIG. 13, in the process P22, the microprocessor 61 requests the peripheral circuits such as the image processing circuit 53 to perform a compressing process and, after that, shifts to the operation stop mode. During the microprocessor 61 is in the operation stop mode, the image processing circuit 53 performs the image compressing process. Since a timer interruption generates at predetermined intervals by the timer circuit 56, the microprocessor 61 is reset from the operation stop mode to the normal mode at predetermined intervals.

More specifically, first, the interrupt request signal S1 is transmitted by the timer circuit 56 to the interruption controller 63. In response to the interrupt request signal S1, the interruption controller 63 transmits the interrupt signal S2 to the microprocessor 61 and transmits the clock start signal S3 to the clock supplying circuit 65. The microprocessor 61 which has received the interrupt signal S2 receives clocks of which supply is restarted from the clock supplying circuit 65, thereby entering an active state (reset to the normal mode).

In the interrupt routine executed at the time of resetting, the microprocessor 61 checks whether the image compressing process has been finished or not.

When it is determined that the image compressing process by the image processing circuit 53 has not been finished yet, the microprocessor 61 transmits the clock stop signal S5 to the clock supplying circuit 65 to thereby stop the supply of clocks to the microprocessor 61, and shifts itself to the operation stop mode again.

On the other hand, when the microprocessor 61 determines that the image compressing process by the image processing circuit 53 has been finished, the microprocessor 61 shifts to a process to be performed next to the image compressing process (that is, the image recording process).

As described above, whether or not the image compressing process has been finished by the timer interrupting process of predetermined interval is determined. If completion of the process is determined, the microprocessor can shift to the next process (image recording process).

In the period from the time the microprocessor 61 requested the image processing circuit 53 to perform the image compressing process to the time the image compressing process is finished except for the period in which the timer interrupting process by the microprocessor 61 is executed, the supply of clocks to the microprocessor 61 is stopped, and the microprocessor 61 is in the operation stop mode. Therefore, power consumption can be reduced.

It is preferable to determine the timer interval of the timer circuit 56 to an appropriate value. Description will be given in this respect.

When the interval of the timer is set to be long, the frequency of timer interruption decreases, so that power consumption can be further reduced. However, time to detect the end of the image compressing process or the like becomes long. Specifically, since a time lag from the actual end of the image compressing process until the end of the image compressing process is detected by timer interruption increases, the processing time becomes longer.

On the other hand, when the timer interval is shortened, the frequency of timer interruption increases, so that an effect of reducing power consumption becomes relatively small. However, the time lag (time deviation) between actual end of the image compressing process and detection of the end of the image compressing process by timer interruption can be decreased. Therefore, time required for the image compressing process can be further shortened.

By determining the timer interval to an appropriate value as described above, the balance between reduction in power consumption and length of processing time can be appropriately adjusted according to the purpose.

B2. Details of Operations

Image Capturing Process and Image Adjusting Process

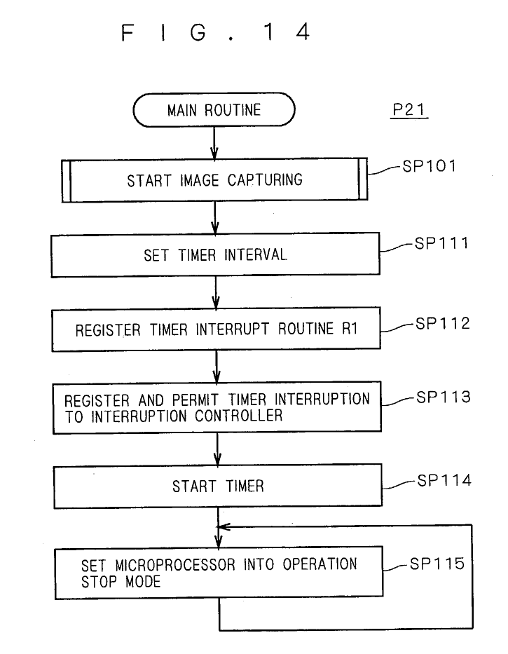

With reference to FIGS. 14 to 21, the operations in the digital camera 1B of the second embodiment will be described. FIGS. 14 to 21 are flowcharts showing the operation.

The microprocessor 61 executes the process P21. The process P21 (see FIGS. 13 and 14) is a process including steps SP101 to SP115.

Concretely, as shown in the flowchart of FIG. 14, first, the image capturing process is performed in step SP101.

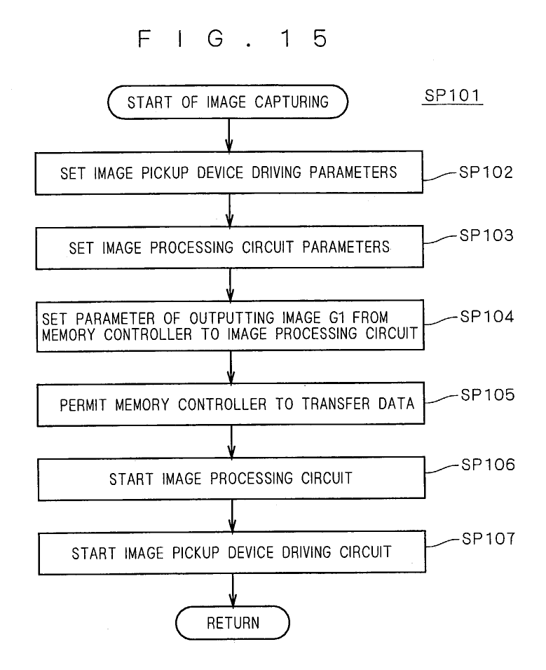

FIG. 15 is a diagram showing the details of the image capturing process in step SP101. Step SP101 includes sub steps SP102 to SP107. In steps SP102 to SP107, the same processes as those of steps SP11 to SP18 (FIG. 5) are performed. Concretely, in steps SP102, SP103, SP104, SP105, SP106 and SP107, the same processes as those in steps SP11, SP12, SP14, SP16, SP17 and SP18 are performed, respectively.

In the following step SP111 (FIG. 14), the timer interval is set. In step SP112, a timer interrupt routine R1 is registered. In step SP113, the microprocessor 61 sets the interruption controller 63 so as to permit reception of the interrupt request signal S1 from the timer circuit 56. In step SP114, the microprocessor 61 starts the timer. In step SP115, the microprocessor 61 shifts itself to the operation stop mode. Concretely, the microprocessor 61 outputs the clock stop signal S5 to the clock supplying circuit 65, thereby stopping the supply of clocks from the clock supplying circuit 65 to the microprocessor 61.

On the other hand, according to steps SP106 and SP107, the image pickup device driving circuit 51 and the image processing circuit 52 start operating. Concretely, the image pickup device driving circuit 51 drives the image pickup device 10 and outputs captured image data of the subject to the image processing circuit 52. The image processing circuit 52 performs a predetermined image adjusting process on the captured image data sent from the image pickup device 10 and outputs the adjusted data as still image data G1 to a predetermined address in the memory 20. In such a manner, the still image data G1 is generated and stored into a predetermined address in the memory 20 (see FIG. 3).

As shown in FIG. 13, also after the process P21 is finished and the microprocessor 61 shifts to the operation stop mode, the timer interrupt routine R1 starts at predetermined intervals.

Concretely, after lapse of time (timer interval) set in step SP111, the timer circuit 56 outputs the interrupt request signal S1 to the interruption controller 63 in order to reset the microprocessor 61 in the operation stop mode to the normal mode. In response to the interrupt request signal S1, the interruption controller 63 outputs the interrupt signal S2 to the microprocessor 61 and also outputs the clock start signal S3 to the clock supplying circuit 65. The clock supplying circuit 65 which has received the clock start signal S3 restarts supplying the clocks S4 to the microprocessor 61. In response to the interrupt signal S2, the microprocessor 61 receives again the clocks S4 supplied, is reset from the operation stop mode to the normal mode, and executes the timer interrupt routine R1.

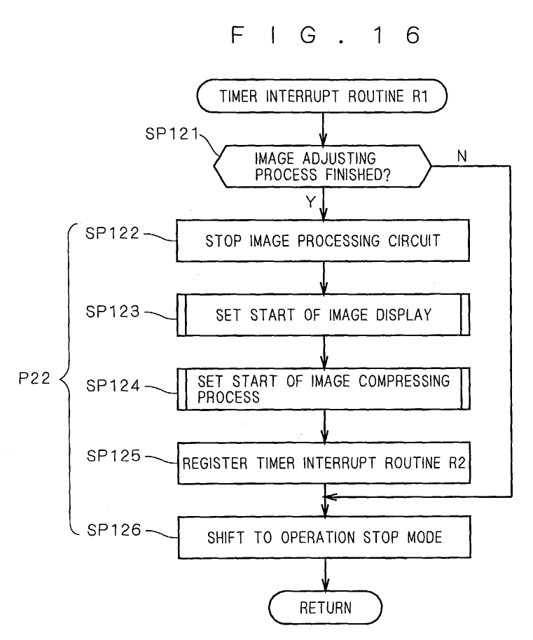

FIG. 16 is a diagram showing the detailed operation of the timer interrupt routine R1.

In the timer interrupt routine R1, in step SP121, whether the image adjusting process by the image processing circuit 52 has been finished or not is determined. Concretely, the microprocessor 61 recognizes the state of the image processing circuit 52 and performs the determining operation. When it is determined that the image adjusting process is not finished yet, the program advances to step SP126 where the microprocessor 61 shifts itself to the operation stop mode again.

As described above, the microprocessor 61 does not receive clocks supplied and is in the operation stop mode, so that power consumption can be reduced.

While the operation of detecting completion of the image adjusting process is performed by using such timer interruption at predetermined intervals, the image adjusting process by the image processing circuit 52 is completed. At this time, it is determined in step SP121 that the image adjusting process has been completed, and the microprocessor 61 executes the process P22 (FIG. 13). The process P22 includes processes in steps SP122 to SP126 as shown in FIG. 16.

Image Displaying Process and Image Compressing Process

The details of the process P22 will be described.

First, in step SP122 (FIG. 16), the microprocessor 61 stops the image processing circuit 52.

After that, the microprocessor 61 executes the processes in steps SP123 to SP126 to thereby make the image displaying circuit 54 start the image displaying process and make the image processing circuit 53 start the image compressing process.

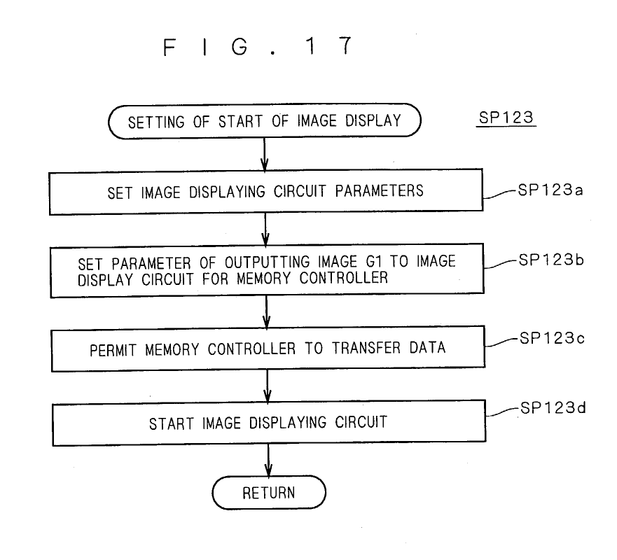

Concretely, first, in step SP123, a process for making the image displaying circuit 54 start the image displaying process is performed. FIG. 17 is a flowchart showing detailed operation of step SP123. In sub steps SP123a, SP123b, SP123c and SP123d of step SP123, the same processes as those in the sub steps SP24a, SP24b, SP24c and SP24d of step SP24 (FIG. 7) are performed, respectively.

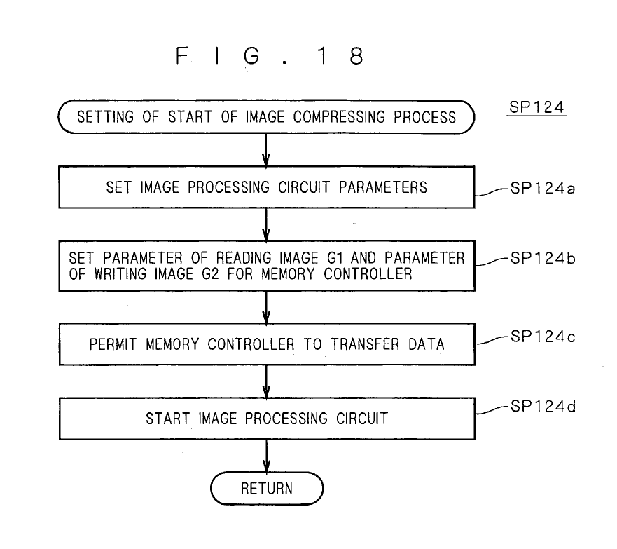

Further, in step SP124, a process for making the image processing circuit 53 start the image compressing process is performed. FIG. 18 is a flowchart showing the detailed operation in step SP124. In sub steps SP124a, SP124b, SP124c and SP124d of step SP124, the same processes as those in the sub steps SP25a, SP25c, SP25e and SP25f of step SP25 (FIG. 8) are performed, respectively.

Subsequently, in step SP125 (FIG. 16), the microprocessor 61 registers the timer interrupt routine R2. The timer interrupt routine R2 is a routine which is started at predetermined intervals in response to output signals from the timer circuit 56.

After that, in step SP126, the microprocessor 61 determines that there is no process to be shared and executed and shifts itself to the operation stop mode, thereby finishing the process P22 by the microprocessor 61.

In the period T22 after completion of the process P22, the image processing circuit 53 performs the image compressing process and the image displaying circuit 54 performs the image displaying process.

As shown in FIG. 13, also after the process P22 is finished and the microprocessor 61 shifts to the operation stop mode, the timer interrupt routine R2 is started at predetermined intervals.

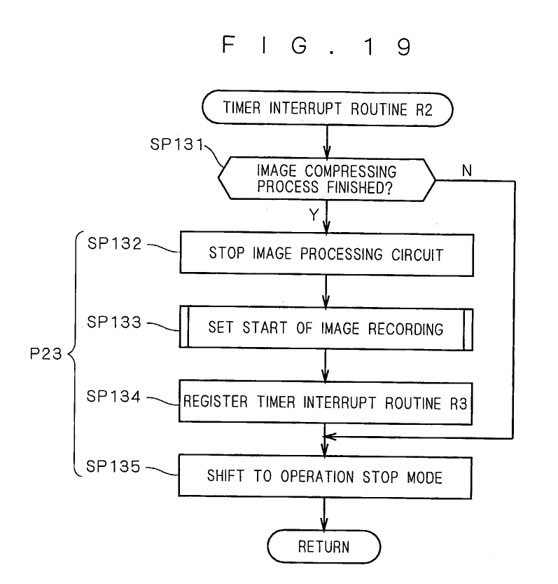

FIG. 19 is a diagram showing the detailed operation of the timer interrupt routine R2.

In the timer interrupt routine R2, in step SP131, whether the image compressing process by the image processing circuit 53 has been finished or not is determined. Concretely, the microprocessor 61 checks the state of the image processing circuit 53 and performs the determining operation. When it is determined that the image compressing process has not been finished yet, in step SP135, the microprocessor 61 shifts itself to the operation stop mode again.

While the operation of detecting completion of the image compressing process is performed by using such timer interruption, the image compressing process by the image processing circuit 53 is completed. The completion of the image compressing process is determined in step SP131, and the microprocessor 61 executes the process P23 (FIG. 13). The process P23 includes, as shown in FIG. 19, the processes in steps SP132 to SP135.

Since the microprocessor 61 does not receive clock supply and is in the operation stop mode in the period TM22, power consumption can be reduced.

Image Recording Process

The details of the process P23 will now be described.

First, in step SP132 (FIG. 19), the microprocessor 61 stops the image processing circuit 53.

After that, the microprocessor 61 executes the processes in steps SP133 to SP135, thereby making the image recording circuit 55 start the image recording process.

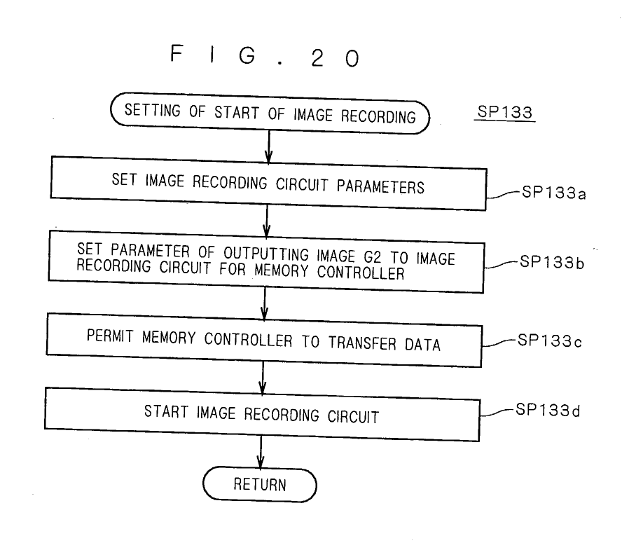

Concretely, in step SP133, a process for making the image recording circuit 55 start the image displaying process is performed. FIG. 20 is a flowchart showing detailed operation of step SP133. In sub steps SP133a, SP133b, SP133c and SP133d of step SP133, the same processes as those in the sub steps SP34a, SP34c, SP34e and SP34f of step SP34 (FIG. 10) are performed, respectively.

Further, in step SP134 (FIG. 19), the microprocessor 61 registers the timer interrupt routine R3. The timer interrupt routine R3 is a routine which is started at predetermined intervals in response to output signals from the timer circuit 56.

After that, in step SP135, the microprocessor 61 determines that there is no process to be shared and executed and shifts itself to the operation stop mode, thereby finishing the process P23 by the microprocessor 61.

In the period TM23 after completion of the process P23, the image recording circuit 55 performs the image recording process.

As shown in FIG. 13, also after the process P23 is finished and the microprocessor 61 shifts to the operation stop mode, the timer interrupt routine R3 starts at predetermined intervals.

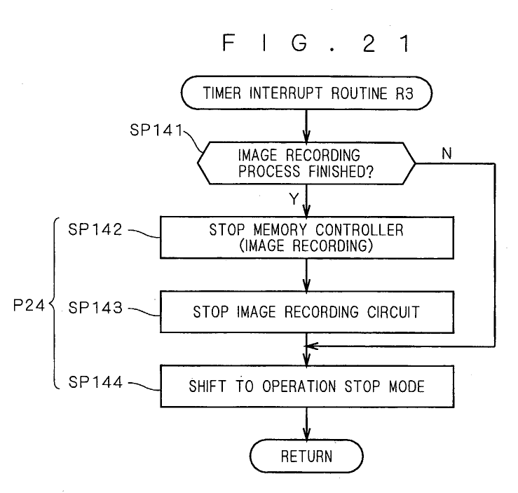

FIG. 21 is a diagram showing the detailed operation of the timer interrupt routine R3.

In the timer interrupt routine R3, in step SP141, it is determined whether the image recording process by the image recording circuit 55 has been finished or not. Concretely, the microprocessor 61 recognizes the state of the image recording circuit 55 and performs the determining operation. When it is determined that the image compressing process has not been finished yet, in step SP144, the microprocessor 61 shifts itself to the operation stop mode again.

While the operation of detecting completion of the image recording process is performed by using such timer interruption, the image recording process by the image recording circuit 55 is completed. The completion of the image recording process is determined in step SP141, and the microprocessor 61 executes the process P24 (FIG. 13). The process P24 includes, as shown in FIG. 21, the processes in steps SP142 and SP143.

Since the microprocessor 61 does not receive clock supply and is in the operation stop mode in the period TM23, power consumption can be reduced.

Finishing Process

The details of the process P24 will now be described. The process P24 is a process of finishing the image recording. Concretely, as shown in FIG. 21, the microprocessor 61 stops the memory controller 59 (step SP142) and stops the image recording circuit 55 (step SP143).

After that, the microprocessor 61 does not have a process to be shared and executed and, therefore, shifts itself to the operation stop mode (step SP144). The operation stop mode is maintained until the next task occurs. In the operation stop mode, supply of clocks from the clock supplying circuit 65 to the microprocessor 61 is stopped, so that power consumption can be reduced.

After that, in a manner similar to the first embodiment, after lapse of predetermined time, in response to the interrupt request signal S1 from the timer circuit 56, or the like, the microprocessor 61 shifts to the normal mode, and the live view displaying operation in the digital camera is realized.

C. Third Embodiment

A third embodiment will now be described.

A digital camera 1C according to a third embodiment operates a real-time OS (Operating System) in the microprocessor 61 and realizes functions similar to those in the second embodiment by using the real-time OS. In the following, different points from the second embodiment will be mainly described.

By the real-time OS, a plurality of tasks (processes) can be switched according to the priority of each task and executed. Also during execution of a predetermined task, interruption can be accepted in a real-time manner, and a task newly occurs by interruption and a task being executed can be switched and executed according to the priorities of the tasks.

By using the real-time OS, software designing is facilitated. Particularly, when the scale of software to be developed is large, the designing work tends to be difficult. However, by using the real-time OS as in the embodiment, software for performing a high-speed and reliable process can be realized by a relatively easy designing work.

In the third embodiment, for example, at the time point of start-up of the real-time OS, a timer for generating an interrupt request signal every predetermined time is set. The timer function is realized by setting a predetermined value for the timer circuit 56. As a routine started in response to the interrupt request signal from the timer, that is, as a timer interrupt routine, a routine for switching a plurality of tasks is registered in the microprocessor 61.

In cooperation with the real-time OS, the routine determines one of a plurality of tasks to be executed at that time point on the basis of priorities of the tasks on generation of interruption from the timer. In the case where a task being executed already exists at the time point of interruption and it is determined that a task having a higher priority than the task being executed is registered, the task being executed is temporarily interrupted, and the right to be executed is given to the task having a higher priority. On the other hand, if only tasks having priority lower than that of the task being executed at present are registered, the task being executed at present is continuously executed. In such a manner, the interrupt routine determines the task to be executed and is finished after the determination. As described above, in the real-time OS, when a plurality of tasks compete with each other, adjustment is made in consideration of the priorities of the tasks, and the task can be switched at predetermined intervals.

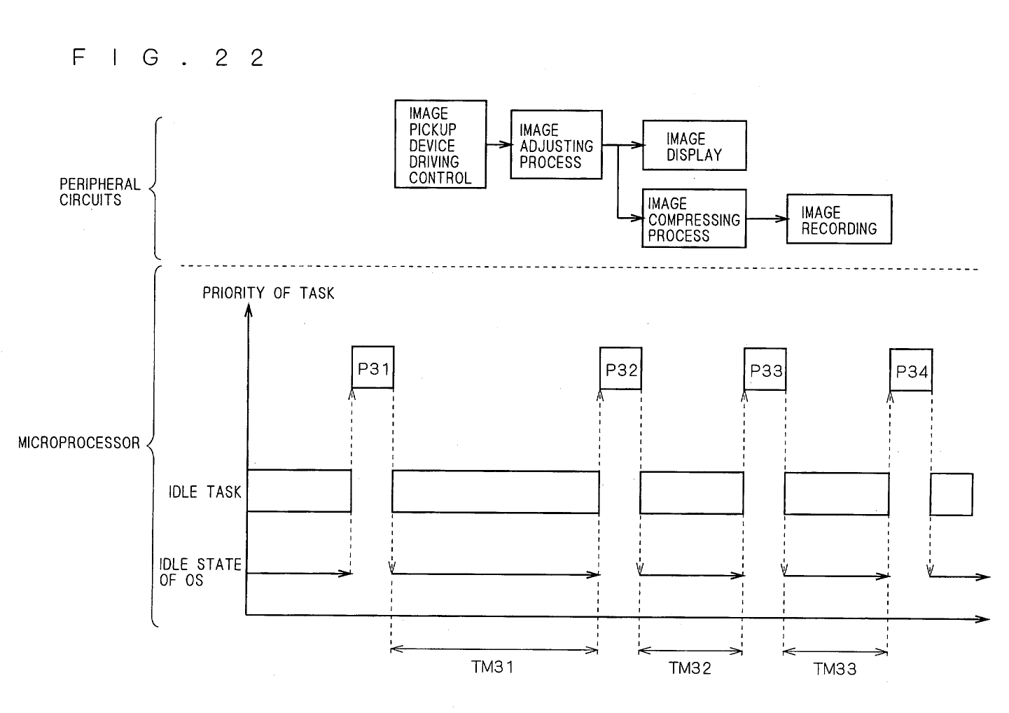

FIG. 22 is a diagram showing processes performed by the microprocessor 61 and processes performed by the peripheral processing circuits in the digital camera 1C of the third embodiment with lapse of time.

As shown in FIG. 22, a task of stopping supply of clocks (hereinafter, also referred to as “idle task”) is registered on the real-time OS. The idle task is registered as a task having the lowest priority in the plurality of tasks to be executed in the real-time OS.

On the other hand, the tasks other than the idle task, in other words, other substantial processes P31, P32, P33 and P34 to be executed by the microprocessor 61 have priorities higher than the idle task. The processes P31, P32, P33 and P34 are similar to the processes P21, P22, P23 and P24 (or P1, P2, P3 and P4), respectively.

Each of the processes P31, P32, P33 and P34 is started according to interruption from any of the peripheral processing circuits. More specifically, any of the processes P31, P32, P33 and P34 is registered as a process to be executed in the real-time OS in accordance with interruption from corresponding one of the peripheral processing circuits.

When it is determined that the priority on a process newly registered is higher than that of an idle task, the newly registered process is immediately executed.

After that, when all of processes (tasks) having priority higher than that of the idle task are completed, a process to be shared and executed does not exist in the microprocessor 61. Concretely, in a period TM31 in which the image pickup device driving process and the image adjusting process are performed by the image pickup device driving circuit 51 and the image processing circuit 52, respectively, a period TM32 in which the image compressing process is performed by the image processing circuit 53, and a period TM33 in which the image recording process is performed by the image recording circuit 55, a process to be shared and executed does not exist in the microprocessor 61. This state corresponds to a state where the following condition is satisfied. The condition is such that, at the time of executing processes on image data, a process to be shared and executed does not exist in the microprocessor 61 after the microprocessor 61 has requested the peripheral processing circuits to perform at least a part of the data process.

In this case, the idle task is executed. The idle task executes a process for stopping supply of clocks to the microprocessor 61. Concretely, the microprocessor 61 transmits the clock stop signal S5 to the clock supplying circuit 65. Accordingly, supply of the clocks S4 from the clock supplying circuit 65 to the microprocessor 61 is stopped. By easily and reliably stopping supply of unnecessary clocks, power consumption can be reduced.

Although the case where the tasks P31, P32, P33 and P34 are started when any of the peripheral processing circuits directly interrupts the microprocessor 61 has been described above, the present invention is not limited to the case. For example, it is also possible to interrupt the microprocessor 61 by the timer circuit 56 and, in a timer interrupt routine started by the interruption, start any of the tasks P31, P32, P33 and P34. More specifically, it is sufficient to monitor the status of the peripheral processing circuit by the microprocessor 61 in the timer interrupt routine and, when completion of a requested process in the peripheral processing circuit is detected by the microprocessor 61, start each of the tasks P31, P32, P33 and P34.

D. Others

Inhibition of Sleep

The above-described second and third embodiments have been described with respect to the case where at the time of performing a data process on image data, whether the predetermined condition is satisfied or not is determined by using the timer interrupt process at predetermined intervals and, when the predetermined condition is satisfied, the supply of clocks from the clock supplying circuit 65 to the microprocessor 61 is stopped.

The processes include, however, a process causing large deterioration in response due to such stop of supply of clocks. Concretely, there is a case of performing a process related to an access to an image recording medium.

Although not specifically described in the second embodiment, when a piece of still image data is written and recorded on the image recording medium 40 (or data is read from the image recording medium 40 and reproduced), there is a case such that the microprocessor 61 has to make setting of writing (or reading) of data to/from the image recording circuit 55 not once but a plurality of times on the unit basis of a sector in the image recording medium. In other words, there is a case that the microprocessor 61 has to perform an access control on a sector unit basis.

The image recording medium is divided in small recording units called sectors and one piece of still image data is recorded in a plurality of sectors. Therefore, at the time of recording one piece of still image data, the access control on each of the plurality of sectors is required. The access control on the sector unit basis may be performed by the image recording circuit 55 itself or by the microprocessor 61.

In the latter case (that is, in the case where the access control on the sector unit basis is performed by the microprocessor 61), at the time of recording a piece of still image data, every time each of the sectors in the image recording circuit 55 is accessed, the microprocessor 61 repeats the setting operation to the image recording circuit 55. After completion of the access operation (writing operation or reading operation) on one sector, the microprocessor 61 has to directly inquire the image recording medium 40 of “whether the next sector may be accessed or not”. If the supply of clocks to the microprocessor is stopped, due to the time lag until restart by the timer interruption, a problem arises such that the operating speed deteriorates, in other words, response deteriorates.

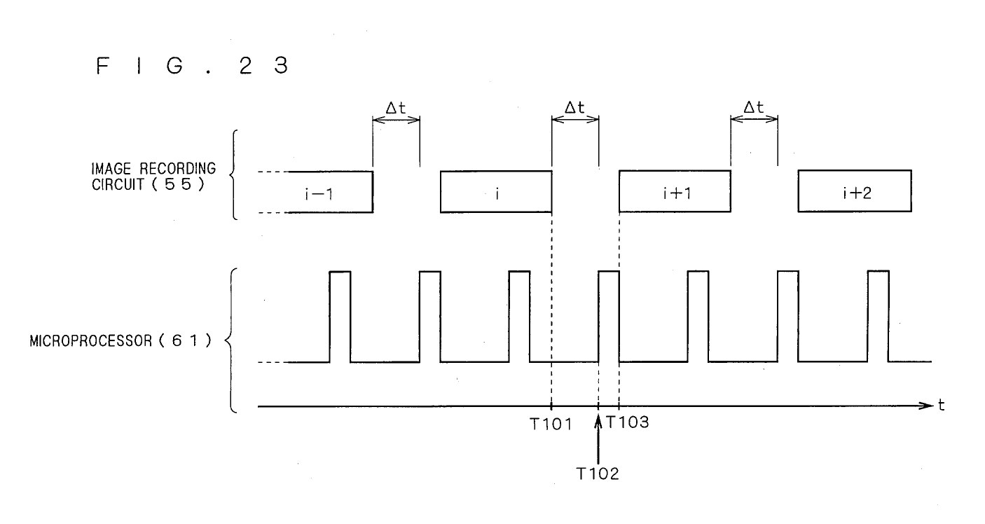

FIG. 23 is a conceptual diagram for describing the problem. FIG. 23 conceptually shows the operations of the image recording circuit 55 and the microprocessor 61 in the case where it is assumed that the process of recording image data to each of the sectors in the image recording medium 40 is realized by timer interruption.

For example, at the time point (time T101) when an operation of accessing the i-th sector by the image recording circuit 55 is finished, the microprocessor 61 has already shifted to the operation stop mode. After that, when the microprocessor 61 is restarted by the timer interruption and reset to the normal mode (time T102), the microprocessor 61 inquires the image recording medium 40 of whether the next (i+1)th sector can be accessed or not. When a positive answer to the inquiry is obtained, the microprocessor 61 requests the image recording circuit 55 to access the (i+1)th sector and shifts itself again into the operation stop mode (time T103).

At the time point (time T101) when the access process on a predetermined sector by the image recording circuit 55 is completed, the microprocessor 61 is in the operation stop mode. Consequently, from this time point (time T101) until the time point (time T102) when the microprocessor 61 is reset from the operation stop mode to the normal mode by timer interruption, a time lag Δt having length of about “timer interval” at the maximum is generated. Although one time lag Δt is short time, if such a time lag Δt is generated every time each of the plurality of sectors is accessed, the total of the time lags At becomes an unignorable value. As a result, it causes increase in processing time, in other words, deterioration in response.

To prevent such deterioration in response, when the process of accessing the image recording medium 40 is performed, it is preferable that the clock supplying circuit 65 continue supplying clocks to the microprocessor 61 without stopping the supply.

Concretely, when the microprocessor 61 performs the process regarding access to the image recording medium 40 in cooperation with the image recording circuit 55, the microprocessor 61 itself is not shifted to the operation stop mode. In other words, when the process (writing or reading process) accompanying access to the image recording medium 40 is performed, the microprocessor 61 continues the operation in the normal mode without being shifted to the operation stop mode. As a result, even when the predetermined condition is satisfied, the microprocessor 61 continues the operation in the normal mode. When the process (writing or reading process) accompanying access to the image recording medium 40 is not performed, as described above, by shifting the microprocessor 61 itself to the operation stop mode, reduction in power consumption can be realized.

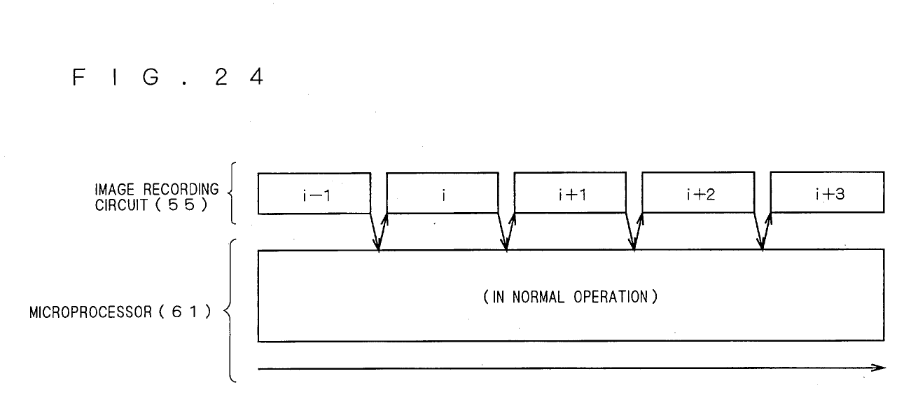

FIG. 24 is a diagram for describing the detailed operation. As shown in FIG. 24, the microprocessor 61 repeatedly monitors the state of the image recording circuit 55 while continuing the operation in the normal mode. On detection of completion of the process of accessing a predetermined sector, the microprocessor 61 starts the process of accessing the next sector. More specifically, the microprocessor 61 instructs the image recording circuit 55 to perform an actual recording process.

By such operation, generation of the time lag Δt can be prevented, so that higher processing speed can be achieved.

As described above, at the time of executing the process related to access to the image recording medium, it is preferable to continue supplying clocks from the clock supplying circuit 65 to the microprocessor 61 without shifting the microprocessor 61 into the operation stop mode.

As a process related to access to the image recording medium (in other words, the process in which it is not preferable to shift the microprocessor 61 to the operation stop mode), not only a process on only one piece of still image data but also a process on plural pieces of still image data exist.

The larger the number of times of accessing sectors is, the larger the integrated value of the time lags At becomes. Consequently, the problem becomes conspicuous particularly in the case where successive access control on the sector unit basis on the plural pieces of still image data is necessary. For example, the problem becomes conspicuous in a “continuous image capturing process” and a “continuous reproducing process”. In other words, when the continuous access control on the sector unit basis is performed on the plural pieces of still image data, without shifting the microprocessor 61 to the operation stop mode, supply of clocks from the clock supplying circuit 65 to the microprocessor 61 may be continued, thereby enabling response to be largely improved.

Conversely, with respect to a data process of which response is not requested to be improved so much, when a predetermined condition is satisfied, the microprocessor 61 may be shifted to the operation stop mode. In such a manner, priority may be placed on the demand for reducing power consumption. For example, with respect to the data process on one piece of still image data, like in the second and third embodiments, the microprocessor 61 may be shifted to the operation stop mode in the case where the predetermined condition is satisfied.

Hereinafter, the “continuous image capturing process” and the “continuous reproducing process” will be described.

First, the continuous image capturing process will be described. The “continuous image capturing process” denotes a process of continuously recording plural pieces of still image data included in image data into the image recording medium 40. The “continuous image capturing process” includes a so-called “motion image capturing”. The continuous image capturing is not limited to the “motion image capturing” but also includes so-called “continuous photographing”.

In order to realize such a continuous image capturing process, it is also possible to store a plurality of still images continuously captured into a memory as a buffer and, after completion of the image capturing, transfer and record the plurality of still images in the memory in a lump to the image recording medium 40. However, the process of transferring the images in a lump from the memory to the image recording medium 40 requires relatively long time, so that the next continuous image capturing cannot be started immediately. In this case, the user cannot acquire an image when he/she wants and misses the good timing to take a good picture.

In order to avoid such a situation, in parallel with the still image capturing process in the continuous image capturing, plural pieces of still image data subjected to the image process are continuously transferred by using the image recording circuit 55 to the image recording medium 40 and stored (recorded) into the image storing medium 40. By performing the image recording process by cooperative operation of the image recording circuit 55 and the microprocessor 61 capable of performing high-speed processes, the speed of the recording process is increased. As a result, the user can perform the continuous image capturing process without missing a chance to take a good picture.

In such a system configuration, however, a process of writing (recording) an image on a sector unit basis to the image recording medium 40 is frequently generated. Consequently, as described above, when each of the plurality of writing processes on the sector unit basis is performed according to the timer interruption while determining the condition by the timer interruption, the integrated value of the time lags At becomes large, so that the processing time required for the recording process increases.

At the time of performing such a continuous image capturing process, the clock supplying circuit 65 continues supplying clocks to the microprocessor 61 without stopping the supply. Since it can prevent generation of the time lag Δt, response can be improved.

The “continuous reproducing process” will now be described. The “continuous reproducing process” denotes a process of continuously reading plural pieces of still image data included in image data from the image recording medium 40. The “continuous reproducing process” includes a so-called “motion image reproduction” but it not limited to the “motion image reproduction”. A so-called “pre-reading and reproducing process” of preliminarily reading still images other than a displayed image for the time of reproducing a plurality of still images is also included.

The “pre-reading and reproducing process” will now be described. In a reproduction mode of a digital camera, the microprocessor 61 sequentially reads still image data from the image recording medium 40 and sequentially displays the still image onto the image display 30 such as an LCD. By the displayed still image, the operator of the digital camera can recognize the details of each still image.

However, since a piece of still image data is often large data, the process of reading the still image data requires relatively long time. Therefore, when still image data starts to be read from the image recording medium 40 in response to a request of displaying the next still image from the operator, the operator has to wait until the still image is displayed. To avoid such a problem, on completion of the process of reading predetermined still image data, the process of reading the following still image data is immediately performed. That is, the following still image data is “pre-read”. In such a manner, the response in the case of sequentially displaying the following still images can be improved and the operability can be increased.

In such a “pre-reading and reproducing process”, it becomes frequent to read image data from the image recording medium. Therefore, in the case of stopping supply of clocks to the microprocessor, in a manner similar to the continuous image capturing process, that is, as the integrated value of the time lags At increases, the time until the next still image display in the operation of reproducing a plurality of still images becomes longer. That is, “turn speed” decreases and comfortableness in operation deteriorates.

At the time of performing such a continuous reproducing process, preferably, the clock supplying circuit 65 continues supplying clocks to the microprocessor 61 without stopping the supply. Consequently, generation of the time lag Δt can be prevented, so that response can be improved.

It is also preferable not to stop supply of clocks in the continuous image capturing process and the continuous reproducing process as described above also in the case of using the real-time OS in the third embodiment.

Concretely, it is sufficient to specify the details of the process of the idle task so that the microprocessor 61 itself is not shifted into the operation stop mode in a process accompanying an access to the image recording medium 40. For example, whether a process accompanying an access to the image recording medium 40 is being performed or not is determined. If it is determined that the process accompanying the access to the image recording medium 40 is not being performed, the microprocessor 61 itself is shifted into the operation stop mode. On the other hand, if it is determined that the process accompanying an access to the image recording medium 40 is being performed, the following process is continuously performed without shifting the microprocessor 61 itself to the operation stop mode. It is sufficient to specify such processes as an idle task. In this case, the clock supplying circuit 65 continuous supplying clocks to the microprocessor 61 without stopping the supply and the microprocessor 61 continues the operation in the normal mode. In such a manner, generation of the time lag Δt can be prevented, so that response can be improved.

Other modifications

In each of the above-described embodiments, the microprocessor 61, image pickup device driving circuit 51, image processing circuits 52 and 53, image displaying circuit 54, image recording circuit 55, memory controller 59, interruption controller 63, clock supplying circuit 65 and the like are constructed on the inside of a single IC chip 50 for image processing. The present invention is not limited to the configuration. Each of the circuits may be independently provided as different hardware (for example, IC chip).

While the invention has been shown and described in detail, the forgoing description is in all aspects illustrative and not restrictive. It is therefore understood that numerous modifications and variations can be devised without departing from the scope of the invention.

What is claimed is:

1. A digital camera comprising:
a central processing unit;
a peripheral processing circuit for sharing a data process on image data with said central processing unit; and
a clock supplying circuit for supplying clocks to said central processing unit,
wherein said clock supplying circuit stops supplying clocks to said central processing unit when said central processing unit requests said peripheral processing circuit to execute at least a part of a predetermined data process and the condition that there remain no process parts to be executed by said central processing unit is satisfied.

2. The digital camera according to claim 1, wherein
said central processing unit and said peripheral processing circuit are operable to share another data process different from said predetermined data process,
timer interrupts at predetermined time intervals are generated to detect whether said condition is satisfied or not during said predetermined data process is executed, and
said clock supplying circuit continues supplying said clocks to said central processing unit even when said condition is satisfied during said another data process is executed in relation to an access to an image recording medium.

3. The digital camera according to claim 2, wherein
said image data includes plural pieces of still image data, and
said another data process includes a continuous image capturing process of continuously recording said plural pieces of still image data to said image recording medium.

4. The digital camera according to claim 3, further comprising:
a memory for storing said image data, wherein
said peripheral processing circuit includes:
a first processing circuit serving as a memory controller; and
a second processing circuit for performing a predetermined process on said image data stored in said memory, and
said first processing circuit transfers said image data between said memory and said second processing circuit to perform an objective process requested by said central processing unit in a period in which supply of clocks to said central processing unit is stopped, and in response to finish of the transfer of said image data, transmits a command for starting said supply of clocks to said clock supplying circuit.

5. The digital camera according to claim 4, further comprising:
a display device capable to display an image represented by said image data, wherein
said second processing circuit is an image displaying circuit operable to generate said image on said display device.

6. The digital camera according to claim 4, wherein
said second processing circuit is an image processing circuit for performing an image processing on said image data stored in said memory.

7. The digital camera according to claim 2, further comprising:
a memory for storing said image data, wherein
said peripheral processing circuit includes:
a first processing circuit serving as a memory controller; and
a second processing circuit for performing a predetermined processing on said image data stored in said memory, and
said first processing circuit transfers said image data between said memory and said second processing circuit to perform an objective process requested by said central processing unit in a period in which supply of clocks to said central processing unit is stopped, and in response to finish of the transfer of said image data, transmits a command for starting said supply of clocks to said clock supplying circuit.

8. The digital camera according to claim 7, further comprising:
a display device capable to display an image represented by said image data, wherein
said second processing circuit is an image displaying circuit operable to generate said image on said display device.

9. The digital camera according to claim 7, wherein
said second processing circuit is an image processing circuit for performing an image processing on said image data stored in said memory.

10. The digital camera according to claim 1, further comprising:
a memory for storing said image data, wherein
said peripheral processing circuit includes:
a first processing circuit serving as a memory controller; and
a second processing circuit for performing a predetermined processing on said image data stored in said memory, and
said first processing circuit transfers said image data between said memory and said second processing circuit to perform an objective process requested by said central processing unit in a period in which supply of clocks to said central processing unit is stopped, and in response to finish of the transfer of said image data, transmits a command for starting said supply of clocks to said clock supplying circuit.

11. The digital camera according to claim 10, further comprising:
a display device capable to display an image represented by said image data, wherein
said second processing circuit is an image displaying circuit operable to generate said image on said display device.

12. The digital camera according to claim 10, wherein
said second processing circuit is an image processing circuit for performing an image processing on said image data stored in said memory.

13. The digital camera according to claim 2, wherein
said image data includes plural pieces of still image data, and
said another data process includes a continuous reproducing process for continuously reading said plurality of pieces of still image data from said image recording medium.

14. The digital camera according to claim 1, wherein
said central processing unit operates with a real-time OS,
a task of stopping supply of clocks is registered as a task having the lowest priority among a plurality of tasks executed by said real-time OS, and
supply of said clocks to said central processing units is stopped in response to execution of said task.
